(19) United States
(12) Patent Application Publication
(10) Pub. No.: US 2009/0018746 A1
(43) Pub. Date: Jan. 15, 2009

(54) Method and Apparatus For Measuring and Correcting an In-Cylinder Pressure Measurement

(75) Inventors: Peter Miller, Bedfordshire (GB); Anthony J. Truscott, West Sussex (GB)

Correspondence Address: OSHA LIANG L.L.P., TWO HOUSTON CENTER, 909 FANNIN, SUITE 3500, HOUSTON, TX, 77010, US

(73) Assignee: Ricardo UK Limited, West Sussex (GB)

(21) Appl. No.: 11/579,659

(22) PCT Filed: Apr. 28, 2005
(86) PCT No.: PCT/GB2005/01631

§ 371 Date: Jun. 6, 2007

(30) Foreign Application Priority Data
May 6, 2004 (GB) 0410135.8

(51) Int. Cl. F02D 41/14

(52) U.S. Cl. 701/102

(57) ABSTRACT

A method and apparatus for obtaining a corrected engine operational parameter value, using cylinder pressure information. A real pressure sensor signal output from a sensor (41D) is compared for discrepancies with an estimated output from engine pressure model (42A), including an engine model and a sensor model. The engine pressure model is corrected dependent on the discrepancy and the model engine pressure is then taken as the output value.

The invention relates to a method and apparatus for obtaining a corrected engine operational parameter value, in particular using cylinder pressure information.

Known engine management systems (EMS) monitor and control the running of an engine in order to meet certain pre-set or design criteria based on engine performance data. Typically the design criteria are good driveability coupled with high fuel efficiency and low emissions, and the engine performance data includes engine cylinder pressure. An internal combustion engine is controlled by an engine control unit which receives sensor signals from a sensor group including a pressure sensor and issues control signals to an actuator group and including, for example valve, spark or fuel injection actuators. The engine control unit also receives external control inputs from external inputs such as throttle controlor gear sensors.

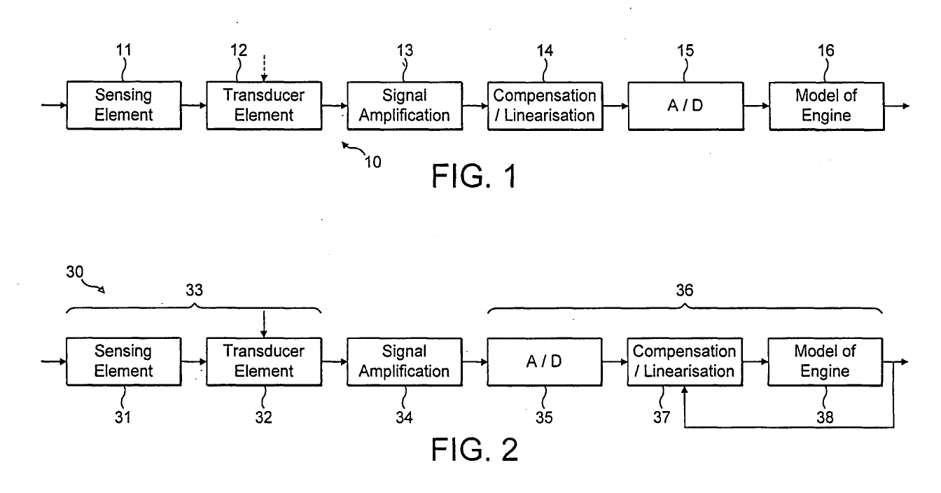

Sensor signals can be obtained from a dynamic cylinder pressure measurement system consisting of a sensing element and a transducer element which provide a signal to signal amplification and normalisation electronics. The signal normalisation electronics are required for signal conditioning to compensate for variabilities and nonlinearities in the raw signal from the pressure sensing element in the cylinder. Such variabilities arise from the temperature dependence of the pressure measurement given by the ideal gas law; PV∂CT and also from hysteresis and sensor drift effects. A typical prior art sensing approach 10 is shown in FIG. 1. In operation a pressure sensing element 11 and a transducer element 12 provide an electrical representation of the pressure in a particular cylinder (not shown). This signal is then amplified at amplifier 13 and passed to the normalisation electronics 14 where it undergoes linearisation and compensation for effects for example of cylinder temperature.

A problem with known systems is that the normalisation electronics require calibration for the complete range of temperatures experienced in the cylinder that depend on engine build, fuel type, combustion control strategy and engine conditions. Also the inherent tolerances of the electronic components in question must be considered. Typical electrical and electronic sensing components can have tolerances as high as 10 percent. Furthermore, normalisation electronics of this type are both costly in terms of production and calibration. In order to be effective each sensing system must be adapted specifically for a particular vehicle specification. Furthermore it is necessary in some cases to embed a temperature sensor into the pressure sensor to compensate for variations in engine temperature. Yet further, such an approach does not compensate for changes in performance arising from in service engine wear nor does it compensate for sensor hysteresis, or real-time sensor drift.

The invention is set out in the claims.

Advantages of the present invention compared to that of the prior art are that the present invention provides an estimation of the cylinder temperature and/or pressure or other engine effects stored in hardware to provide an accurate correction strategy rather than a signal normalisation/conditioning regimen. In addition the transient effects of hysteresis can be overcome by using previously estimated cylinder temperatures and/or pressure, or other engine parameters.

Embodiments of the invention will now be described by way of example with reference to the drawings, of which:

FIG. 1 is a block diagram representing a prior art pressure measurement and engine control unit system;

FIG. 2 is a block diagram representing the general pressure sensing system according to the present invention;

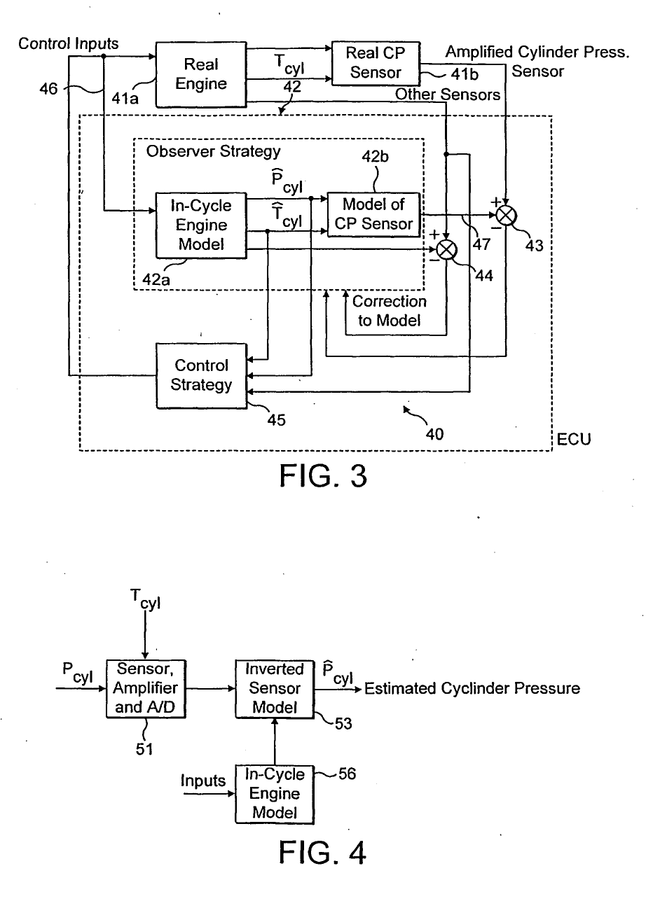

FIG. 3 is a block diagram showing the components of the pressure sensor, model and ECU, according to one embodiment of the present invention;

FIG. 4 is a block diagram showing the components of the ECU, according to a second embodiment of the present invention;

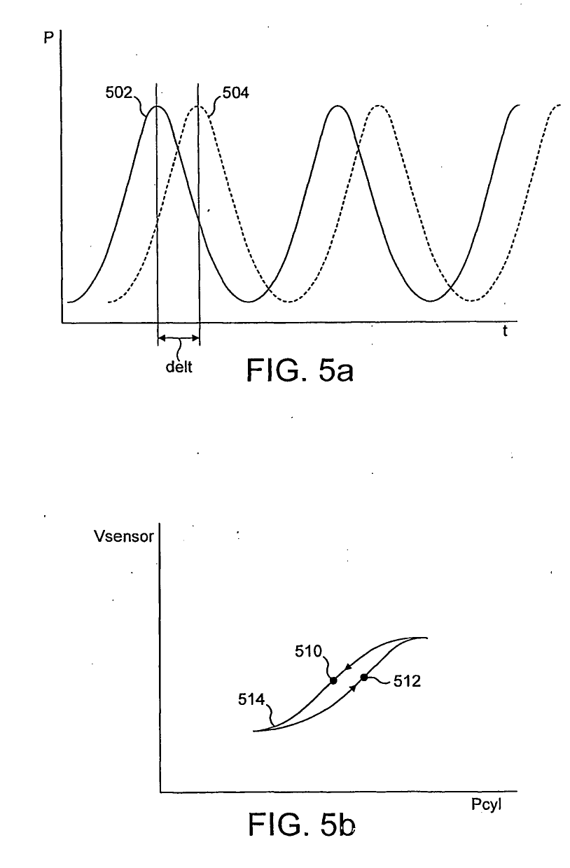

FIG. 5a shows an approach to correcting for time lag in sensed pressure; and

FIG. 5b shows an approach to correcting for hysteresis.

In overview, the invention makes use of a pressure sensor model to compensate for inaccuracies in the raw signal from the real pressure sensor, rather than providing dedicated and application specific compensation hardware. In one embodiment a real pressure sensor signal output is compared for discrepancies with an estimated output from an engine pressure model including an engine model and a sensor model. The engine pressure model is corrected dependent on the discrepancy and the modelled engine pressure is then taken as the output value. Because the sensor model can include a “pure” pressure sensor model and a “pure” temperature sensor model, these values, which will both influence the output of the real pressure sensor, can be decoupled in the model.

In particular, cylinder pressure measurements are carried out whereby inaccuracies inherent with such measurements are taken into account by comparing data provided within a model with actual data and updating the model based on this comparison. Accordingly, effects such as null shift hysteresis and spark timings during the ignition stroke of each cylinder, or where variations in air/fuel ratio are compensated. In particular the model data converges with the actual data to provide an accurate picture of the engine performance for use in an engine management control unit. Furthermore, linearization of the measured parameter takes place after signal amplification thereby allowing manipulation of the sensor signal in accordance with model data.

The sensed cylinder pressure is a function of other operational parameters such as cylinder temperature. Both of these are modelled and the model updated from comparisons of the sensor pressure measurement and the modelled sensor output until convergence is reached. The decoupled value of pressure (or other operational parameters) can then be extracted from the values used by the converted model.

In particular, real-time in-cycle cylinder temperatures are estimated based on current engine cycle observations and used to condition, correct and improve cylinder pressure measurements. As a result temperature sensors embedded in the pressure sensor are not required. The improved pressure measurements are more representative of the real cylinder pressure. Furthermore, the measurements can be used to compensate for dynamic effects such as hysteresis, and can be stored in hardware for correcting future estimations by deciding where on the sensor hysteresis curve the sensor is operating and correcting the sensed pressure measurement accordingly.

Various approaches can be adopted for correcting for hysteresis which can be better understood with reference to FIGS. 5a and 5b. Referring firstly to FIG. 5a which shows a graph of cylinder pressure against time, it will be seen that, as a result of time lags in the sensor hardware, there will be a slight phase difference between the sensed pressure (502) and the ideal pressure (504). Accordingly if the system can identify the time lag ΔT then this can be corrected for in the model output hence giving a yet more accurate measurement for the cylinder pressure. The ideal pressure curve can be obtained, for example, from identifying engine top dead centre using any appropriate sensor. The pressure lag ΔT can be corrected by obtaining an average value for ΔT over successive cycles or by dynamically correcting for each measured ΔT from cycle to cycle.

Referring now to FIG. 5b the hysteresis loop (514) is shown demonstrating the variation in the sensor output dependent on pressure increase or decrease. As is well known, a single value of sensor output can represent two possible values of pressure (510, 512) dependent on where the sensor lies in its cycle. The hysteresis curve (514) can be derived for engine operation for example from historical data stored in the system during sensor output against measured pressure. As a result the corrected value for pressure can be derived from the sensor output by establishing where in the sensor cycle the value was taken, allowing hysteresis correction.

The arrangement shown in FIG. 5a hence allows correction for time delays induced in the system whilst the hysteresis correction described as reference to FIG. 5b allows the system to correct for hysteresis induced, for example, by the specific materials used in the pressure sensor cylinder.

Furthermore as a direct result of using real-time in-cycle cylinder temperature estimations based on the current engine observations it is possible to compensate for sensor drift for example by estimating the polytropic index n variations between engine cylinders and cycles thereby overcoming sensor drift, as discussed in more detail in UK patent application number 0112338.9, incorporated herein by reference.

In another embodiment the real pressure sensor signal output is received as an input by an inverted sensor model which also receives an estimated temperature from an engine model. The output from the inverted model is then the modelled pressure in the engine. It is also contemplated that a real temperature sensor signal is received as an input by the inverted sensor model which can also receive an estimated pressure from an engine model. The output from the inverted model is then the modelled temperature in the engine.

FIG. 2 is a schematic representation of the present invention generally designated 30. This figure depicts a sensor unit 33, which includes a sensing element 31 and transducer element 32. The sensing element 31 is placed in the cylinder of an internal combustion engine (not shown) which is in physical connection with the transducer element 32. Such sensing elements can include inductive, capacitive, piezoelectric or piezoresistive types, for example as provided by Kistler (discussed, for example, in German Patent No. DE10034390). As a result of the pressure change generated in the engine cylinder, the sensor unit 33 provides real time electrical signals that are dependent on the amount of pressure generated in the engine cylinder, before, during and after ignition in the cylinder. To amplify the electrical signal level provided from the sensor unit 33 a signal amplifier 34 is provided. The amplified analogue signal is converted to a digital signal, using an analogue—to—digital converter (ADC) 35. This digital signal is then passed to Engine control unit (ECU) 36, which includes compensation/linearisation means, 37 implemented in software or hardware as appropriate, and an engine model 38. Preferably software is used providing a cheaper and more accurate solution.

As discussed in more detail below the real time digitised signal data from the analogue to digital converter (A/D) 35 is compared with that of the engine model data and the results fed back to modify the engine model 38. Following each iteration, of measure, compare and feedback the engine model data is updated such that pressure data which has undergone normalisation gradually converges with the actual pressure in the cylinder.

FIG. 3 shows a schematic block diagram of one observer based embodiment including an engine 41a and a control strategy 45 governed by an engine control unit (ECU) 40, whereby the outputs from engine model 42a dictate how the control strategy 45 will control the engine.

The engine has control inputs such as throttle or gear selection and additional outputs such as engine speed and power output. The pressure sensor output is received as an input by pressure value comparator 43. The additional sensor outputs are received as inputs by one or more respective additional value comparators 44.

The engine model 42a models engine pressure \hat{P}_{cyl} and temperature \hat{T}_{cyl} based on common control inputs 46 with real engine 41a. The modelled pressure and temperature are received as inputs by a sensor model 42b which outputs a modelled sensor output 47 to the pressure value comparator 43. The engine model also provides additional sensor outputs as inputs to the additional value comparator 44. The engine model 42a contains information related to the engine in question such as fuel type, engine capacity and efficiency. The sensor model 42b contains a prediction of how the real sensor 41b will respond to a given pressure in the modelled engine. The various components individually are well known to the skilled reader e.g. The Ricardo Network Vehicle Controller (see Channon, S & Miller, P, An Advanced Network Vehicle Controller (NVC) To Support Future Technology Applications, Berlin, Germany; Springer-Verlag, 2003, Advanced Microsystems For Automotive Applications 2003, based on VDI/VDE Conference May 2003) which contains the engine model implemented on a Motorola MPC8260 microprocessor.

In operation the observer based approach is implemented as follows. A measurement of the engine cylinder pressure is taken using the real cylinder pressure sensor 41b and dependent on the actual in-cylinder conditions P_{cyl} and T_{cyl}. This measurement is compared to the modelled output at comparator 43. The difference is then fed back into the model 42 in order to update the model data. The predicted pressure and temperature from the model 42 are then fed to an engine control strategy 45 where they are interpreted and used to control the real engine 41a and further update engine model 42a. Following several iterations, in real time, of comparison and feedback, the model data values will approach the real data values until the two values converge. When the two values converge, the model data can be considered to be an accurate prediction of real time engine performance, in terms of cylinder pressure or other modelled parameters.

In order to improve the model yet further, as well as cylinder pressure monitoring, there is also provided yet a further level of monitoring, where additional sensor output data from the engine is compared at comparator 44 with that generated by the model. As with the pressure measurements described above, the real engine data is compared with the model data at the additional value comparator and the difference of this comparison is fed back to update the engine model further.

The steps of reading the pressure and updating the model to control the real engine are carried out in real time thereby constantly updating the model for all engine conditions. Such conditions can include idle, accelerating, decelerating or running at a constant speed. In this way the performance of the engine under all conditions is known and it is thereby possible to provide an engine that approaches maximum efficiency. Furthermore, such a system can also be used to provide feedback of cylinder conditions where the engine is operating under exceptional circumstances, for example where one of the cylinders has failed or where there has been a gradual change in cylinder geometry through engine wear and deterioration, including the hysteresis of the sensor.

The converted pressure value can be used for any appropriate purpose, for example modifying the engine timing for improved performance as described in UK application 0112338.9, incorporated herein by reference.

FIG. 4 shows a further embodiment of the present invention comprising an inverted model approach. According to this embodiment the signal from the sensor means undergoes amplification at block 51 to provide an arbitrary representation of the cylinder pressure (or other parameter such as engine speed or revs) indicative of engine performance. Following amplification and A/D conversion the sensor signal is passed to an ECU where an inverted model of the sensor 53 and a model 56 of the engine is contained. The engine model receives external actuator and other sensor inputs such as throttle position, manifold temperature, etc. The engine model 56 generates a modelled value of cylinder temperature \hat{T}_{cyl} and updates a sensor model, so that the real pressure signal can be reconstructed as an output from the inverted model, \hat{P}_{cyl}, based on the above mentioned external inputs, thereby providing an accurate estimate of the cylinder pressure. It will be appreciated that this approach can be applied to other parameters indicative of engine performance. It will be further appreciated that the engine model can be dynamically updated based on a comparison of \hat{P}_{cyl} and the estimate generated by the in-cycle model In operation the engine (not shown) has control inputs such as engine speed or gear selection. The pressure sensor 51 makes a measurement of the cylinder pressure and the output of the sensor 51 is then received as an input by the inverted sensor model (ISM) 53. The ISM is an inversion of the sensor 51 in that, a raw pressure measurement is received at the input and a real pressure measurement is provided at the output. The ISM is updated by the In-cycle engine model (ICEM) 56 whereby the ICEM provides modelled temperature data \hat{T}_{cyl}, based on the current operating conditions of the engine. The inverted dynamical sensor model 53 contains information related to the real sensor 51. This may be static response characteristics or both static and dynamic characteristics. As a result of the modelled \hat{T}_{cyl} data and the real sensor information the ISM can convert the pressure reading from the sensor 51 into an accurate estimation of the real pressure.

Although the above discussion contemplates correcting the model throughout engine operation, it will be appreciated that model correction can be carried out only during certain parts of engine operation, for example only during certain parts of the cylinder cycle. For example during the exhaust stroke of the cylinder the sensed real pressure values can be disregarded and during this phase the model can remain uncorrected. It will be appreciated that during this phase accurate prediction of the pressure is less significant. Furthermore modelling of the pressure in this phase is more complex, and correction correspondingly so such that computational resources can be saved in this manner. However, during the compression stroke, when air in the cylinder comprises a trapped mass, modelling is simplified and can be derived from the ideal gas law PV=MRT, given that the variation of volume with time is known from the cylinder dimensions and crank shaft position. As a result the modelled values are only updated during significant phases of operation and are frozen during other phases of operation. It will be seen that this approach is particularly applicable where individual phases of operation of the engine are modelled independently such that correction to the models during one phase will not affect the model during other phases.

By virtue of the features described above it will be seen that the invention provides a stable signal output related to cylinder pressure which can be modelled empirically in real time and provides a fast response time beneficial for knock detection and overall stability whilst being able to compensate for slow sensor response times. The invention is robust to cylinder temperature variations and hysteresis effects and can compensate for drift. In addition the (need for conditioning electronics is removed or reduced, reducing the cost as well as the effects of production tolerances. The discussion above is principally directed to obtaining an accurate value for pressure. However, it will be appreciated that it can be expanded to embrace a range of parameters. Indeed where two or more parameters in an engine cylinder affect a sensor output then the model may include modelled “pure” sensors for one or more of the decoupled parameters. In this case the model will be corrected by the real sensor output (which can even be in relation to a parameter unrelated to the modelled parameters) and the modelled sensed value for any of the individual parameters can be obtained. Accordingly the invention extends to a method of obtaining a corrected engine operational parameter value comprising obtaining a measurement of an operational parameter value from said engine using a sensor, independently estimating an operational parameter value measurement updating the estimate based on the measured operational parameter value and providing a corrected engine operational parameter value based on said update estimate.

Although the above description is based on cylinder pressure, it will be appreciated that other sensor data such as engine data or cylinder temperature values can be compared in a similar manner. Instead of an engine or sensor model it could be based on calibrated look up tables or other method of similarly obtaining data on equivalent parameters to establish other known measures of engine performance.

1. A method of obtaining a corrected engine operational parameter value comprising;
obtaining a measurement of an operational parameter value from said engine using a sensor,
independently estimating said operational parameter value measurement,
comparing said estimate with said measurement and updating the estimate based on said comparison, and
providing a corrected engine operational parameter value based on said updated estimate.

2. A method as claimed in claim 1 wherein the estimation is derived from a model of said engine and a model of said sensor, said comparison of said model estimation and said measurement being fed back to said model, and preferably wherein said comparison of said estimated parameter and said measured parameter is performed in computer hardware.

3. A method as claimed in claim 1 in which the corrected operational parameter value relates to the measured operational parameter.

4. A method as claimed in claim 1 wherein said engine operational parameter value is a parameter indicative of engine performance preferably a pressure value or a temperature value.

5. A method claimed in claim 1 in which the estimate is updated only during predetermined phases of operation of the engine.

6. A method as claimed in claim 1 in which one or more related additional operational parameter values are estimated and updated.

7. A method as claimed in claim 6 in which the operational parameter value is a pressure value and the additional operational parameter value is a temperature value.

8. A method as claimed in claim 1 in which the measured operational parameter value is a temperature value and the corrected engine operational parameter value is a pressure value.

9. A method as claimed in claim 1 further comprising modelling a hysteresis response based on obtained measurements or estimates and preferably further comprising determining a hysteresis condition from the modelled hysteresis response and correcting for the hysteresis condition.

10. An apparatus for obtaining a corrected engine operational parameter value comprising a data store and a comparator, wherein;
the data store contains an engine operational parameter value estimator,
the comparator is arranged to compare sensor information indicative of engine operational parameter value and the estimated engine operational parameter value from the data store,
the data store is arranged to update said estimator based on the result of said comparison and provide a corrected engine operational parameter value based on said engine operational parameter value.

11. An apparatus as claimed in claim 10 further comprising an engine control unit.

12. An apparatus as claimed in claim 10 wherein said estimator includes an engine model and a sensor model.

13. An apparatus as claimed in claim 10 wherein said engine operational parameter value is a cylinder pressure measurement or any other engine measurement.

14. An apparatus as claimed in claim 10 further comprising a sensor arranged to provide said sensor information.

15. An apparatus as claimed in claim 10 wherein said sensor information is pressure sensor or temperature sensor information.

16. A method of obtaining an engine operational parameter value comprising;
obtaining a sensor measurement of said operational parameter value from an engine,
passing said measurement as an input to an inverted model of said sensor,
passing a modelled engine condition value to said inverted sensor model from a model of said engine, and
reconstructing said engine operational parameter value as an output from said inverted sensor model.

17. A method claimed in claim 16 wherein said sensor is a pressure sensor.

18. A method as claimed in claim 16 wherein the modelled engine condition value is a cylinder temperature value.

19. A method as claimed in claim 16 where the operational parameter value is a pressure value.

20. An apparatus for obtaining an engine operational parameter value comprising a data store, wherein;
the data store contains an inverted model of said sensor means and a model of said engine,
the inverted sensor model is arranged to receive as an input from a sensor a measurement of the engine operational parameter value,
the engine model is arranged to input modelled engine parameter value to said inverted sensor model and said inverted sensor model is arranged to reconstruct said engine operational parameter value as an output.

21. An apparatus as claimed in claim 20 further including a sensor arranged to provide said measurement.

22. An apparatus as claimed in claim 20 wherein said engine operational parameter value is a cylinder pressure measurement or an engine measurement.

23. An engine including an apparatus as claimed in claim 10.

24. (canceled)

25. (canceled)

26. (canceled)

27. (canceled)
